(19) United States
(12) Patent Application Publication
(10) Pub. No.: US 2023/0278892 A1
(43) Pub. Date: Sep. 7, 2023

(54) A METHOD FOR TREATING PFAS CONTAINING MEDIUM

(71) Applicant: SANEXEN ENVIRONMENTAL SERVICES INC., Brossard (CA)

(72) Inventors: Martin BUREAU, Montreal (CA); Stéphane VENNE, Brossard (CA); Étienne BÉLISLE-ROY, Otterburn Park (CA); Jean-François LAROSE, Saint-Amable (CA); Jean PAQUIN, Sainte-Julie (CA)

(21) Appl. No.: 18/002,915

(22) PCT Filed: Jul. 14, 2021
(86) PCT No.: PCT/CA2021/050969

§ 371 Date: Dec. 22, 2022

Related U.S. Application Data
(60) Provisional application No. 63/051,531, filed on Jul. 14, 2020.

(51) Int. Cl. C02F 1/26; C02F 1/48; C02F 1/28; C02F 1/42

(52) U.S. Cl. CPC C02F 1/26; C02F 1/283; C02F 1/42; C02F 1/488; C02F 2101/36

(57) ABSTRACT

A method for treating water contaminated with hydrophobic and lipophilic molecules, comprising forming an emulsion of the contaminated water with an oil; and separating from the emulsion an oil part charged with a captured amount of the hydrophobic and lipophilic molecules and a treated water part, the treated water having an amount the in hydrophobic and lipophilic molecules reduced by the captured amount of hydrophobic and lipophilic molecules than an initial amount of the hydrophobic and lipophilic molecules in the contaminated water.

### FIELD OF THE INVENTION

The present invention relates to PFAS contamination. More specifically, the present invention is concerned with a method for treating PFAS containing medium.

### BACKGROUND OF THE INVENTION

Contamination with per- and polyfluoroalkyl substances (PFAS) is a growing environmental concern, for example on military bases, airport grounds, environmental sites such as landfills and water treatment plants, industrial sites, municipalities and water networks. PFAS have been used for decades in a range of industrial applications and consumer products. Known as “forever chemicals”, PFAS spread widely in the environment, are bioaccumulative and persistent; very stable; they resist biodegradation once exposed to air, water or sunlight.

PFAS include aliphatic compounds, completely (perfluoroalkylated substances) or partially (polyfluoroalkylated substances) fluorinated, as well as more complex molecules (precursors). PFAS are designed to be extremely soluble in water; chemically stable due a strong C-F bond, and non-volatile, with a vapor pressure close to zero.

PFAS disperse throughout the planetary ecosystems mainly by water circulation. As a result of their mobility and persistency, they may be found everywhere in the environment, including fauna, flora, and human population. Human exposure results from exposure to PFAS present in food, air, house dust, a range of consumer products such as textiles and kitchen utensils for example, as well as in drinking water. PFAS can be detected in the majority of the general population’s blood (serum), breast milk and/or umbilical cord blood for instance.

Only a few of the several thousand substances of the family of PFAS have been studied so far for their toxicity and their persistence in the human organism. Results demonstrated that PFAS may be persistent in the human organism for years, and that PFAS have toxic effects on a number of organs such as the liver, and a number of systems contributing to neurobehavioral disorders or low birth weight for instance, the lipid metabolism, the endocrine system, for example affecting the thyroid and the immune system, and can induce the development of tumors. A correlation between exposure to certain PFAS and the observation of some of these effects has been demonstrated in human populations exposed via their environment.

Currently, PFOA (perfluorooctanoic acid) and PFOS (perfluorooctane sulfonate) are the subject of recommendations and/or standards for drinking water in Canada (PFOA <200 ng/L, PFOS <600 ng/L) and in the United States (PFOA + PFOS <70 ng/L). Public health issues have also led to more severe /criteria in a number of jurisdictions at an international level, and recommended thresholds and standards are regularly updated according to new scientific data. As a reference, concentrations found in the water of contaminated sites, which may reach about 100,000 ng/L and more, can be hundreds or even hundreds of thousands of times higher than concentrations considered safe for drinking water, which, for PFOA and PFOS, vary from a few ng/L to a few hundred ng/L, depending on the jurisdiction.

Currently, filtration on granular activated carbon (GAC) and/or ion exchange resins (IER) are methods used for treating water contaminated with PFAS. Although these methods are currently available and mature, they are based on the capture of PFAS using filtration media, on the form of granular activated carbon and resins respectively, which have a finite capacity to capture PFAS. Once this capture capacity limit is reached, the media need be replaced and disposed of off-site or regenerated on-site; in practice, they are typically destroyed by incineration. Moreover, the higher the concentration of PFAS in water, the faster the media becomes saturated and needs to be replaced, resulting in a direct impact on the cost of the treatment. Thus, although granular activated carbon (GAC) and ion exchange resins (IER) methods allow meeting treatment targets for drinking water or environmental discharges, they are problematic from an economic point of view. Landfills that need to treat leachate at 200 to 400 L/min report that they currently change or regenerate their filtration media every 3 weeks, and in some cases up to once a week. Given the estimated cost of $ 25,000 to $ 50,000 per filter change, typically representing half a million to $ 2.6 million annually depending on the size of the filters and the frequency of changes, such solutions remain very costly.

Other projects relate to the remediation of soils contaminated by PFAS. Volumes of washing water to be treated may require very large volumes of media in a PFAS capture solution. Other methods, such as advanced oxidation (UV, ozone, Fenton free radicals, etc.), have been shown to result in partial degradation of PFAS, thus yielding substances that may be at least as toxic than the original substances, and even more difficult to capture or process.

There is still a need in the art for a method for treating PFAS contamination in water.

The present description refers to a number of documents, the content of which is herein incorporated by reference in their entirety.

### SUMMARY OF THE INVENTION [PATENT AGENT WILL COMPLETE THIS SECTION]

More specifically, in accordance with the present invention, there is provided a method for treating water contaminated with hydrophobic and lipophilic molecules, comprising forming an emulsion of the contaminated water with an oil; and separating from the emulsion an oil part charged with a captured amount of the hydrophobic and lipophilic molecules and a treated water part, the treated water having an amount the in hydrophobic and lipophilic molecules reduced by the captured amount of hydrophobic and lipophilic molecules than an initial amount of the hydrophobic and lipophilic molecules in the contaminated water,

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematical view of a system according to an embodiment of an aspect of the present disclosure;

FIG. 2 a plan view of the system of FIG. 1;

FIG. 3 shows analyses of PFAS contaminated water to be treated and after treatment in a method according to an embodiment of an aspect of the present disclosure; and

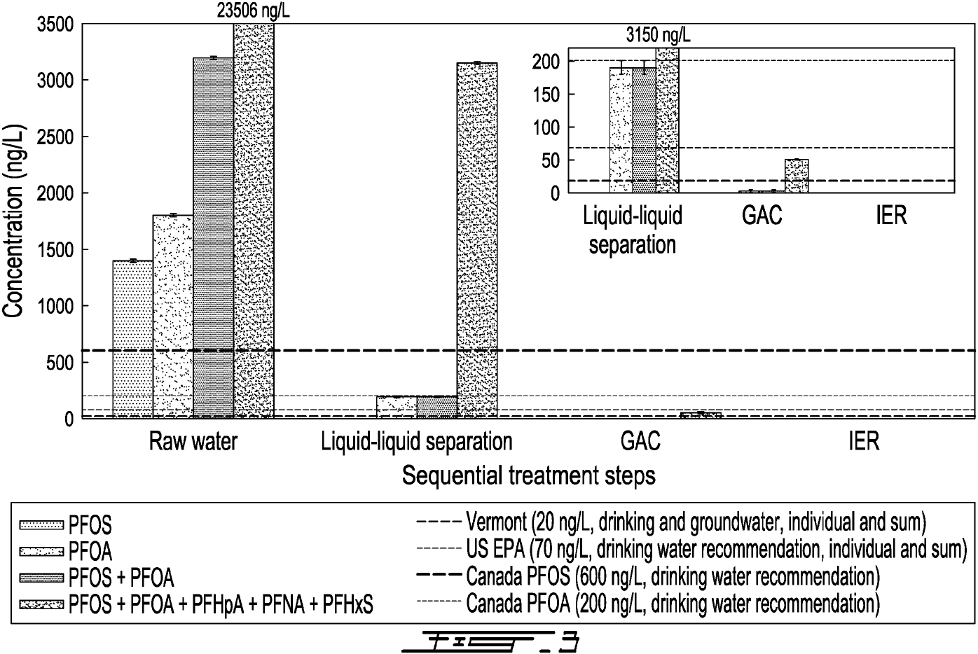

FIG. 4 shows experimental results of PFAS contaminated water treatment with a method according to an embodiment of an aspect of the present disclosure.

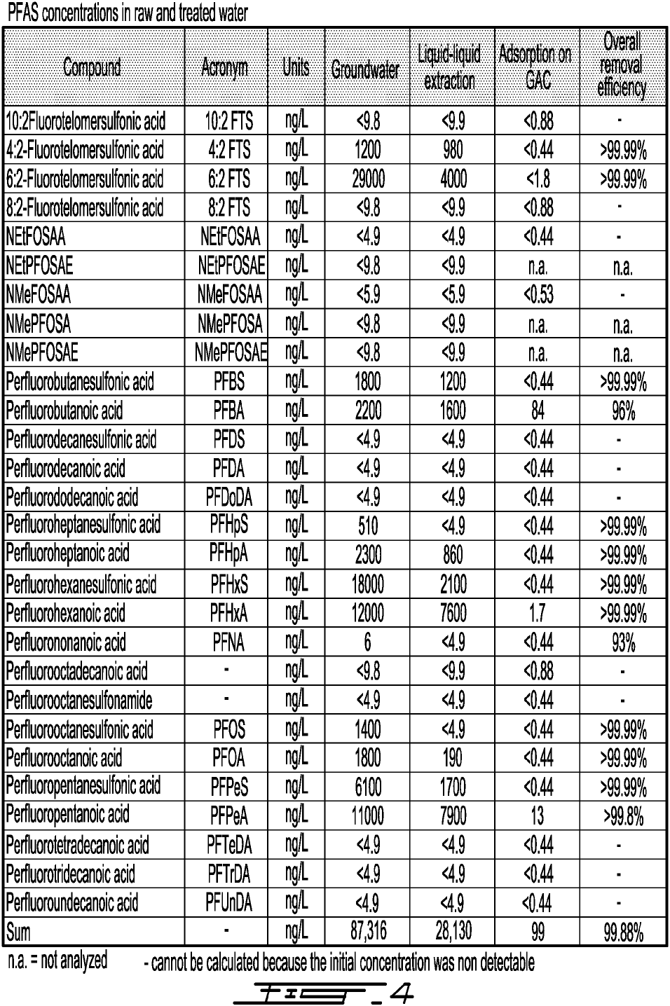

### DESCRIPTION OF ILLUSTRATIVE EMBODIMENTS

The present invention is illustrated in further details by the following non-limiting examples.

In an embodiment of an aspect of the present disclosure, the method comprises forming an emulsion of PFAS-contaminated water with a selected emulsion oil, to generate an oil-water interface formed by oil droplets in the emulsion, which capture PFAS molecules of the contaminated water, and separating resulting PFAS-charged oil and PFAS-discharged water by liquid-liquid separation in a selected oil absorption medium

PFAS molecules comprising a lipophilic tail a hydrophilic head and surfactant properties, have affinity with the oil in the emulsion. The emulsion oil is selected in fonction of a target PFAS removal from the PFAS-contaminated water in the emulsion. An oleophilic and hydrophilic oil absorption medium is selected to capture the oil part of the emulsion, i.e. the PFAS-charged emulsion oil, during liquid-liquid separation.

More precisely, the method comprises determining the physico-chemical parameters of the contaminated water, including PFAS concentration and signature in terms of distribution of PFAS chains lengths, concentration and nature of elements, contaminants or metals that may interfere with PFAS capture by the emulsion oil in the emulsion, and parameters having an impact on oil solubility, such as pH and temperature.

Surfactants for example may interfere with PFAS capture by the oil in the emulsion due to their affinity with oil, thereby taking up interfaces in the emulsion at the expense of PFAS-capture. In an embodiment of the method, in case of interfering surfactants in the contaminated water to be treated, a high emulsion oil concentration is selected and a high injection rate of the emulsion oil in the emulsion with the contaminant water is achieved by first forming a first emulsion oh highly concentrated emulsion oil in clean water, and then injecting the first emulsion into the contaminated water to be treated, which allows reaching emulsion oil concentration in the emulsion with the contaminated water to be treated increased between about 10 and about 20 times while controlling the droplets size in the emulsion, compared to directly forming the emulsion of the contaminated water with the emulsion oil.

Other competing elements, contaminants or metals may interfere with PFAS capture by the oil in the emulsion, by polarity affinity with the emulsion oil or mechanical interference for example; carbonates for example may solidify under specific conditions and form a barrier on the oil droplets, thus limiting access to the PFAS-capturing interfaces in the emulsion.

The method thus comprises controlling formation of the oil-water interface in the emulsion, and controlling PFAS-capturing chemical interactions at the formed oil-water interface, by selecting the type, composition, and concentration of the oil in the emulsion, the shearing parameters and the mixing time for emulsion, according to a target PFAS capture from the contaminated water by the emulsion oil in the emulsion. The emulsion oil is selected according to the physico-chemical characteristics of the water to be treated on the basis of at least one of: its molecular composition, viscosity, density and interfacial tension, in combination with mixing shearing speed and mixing time, to achieve a target size of oil droplets of at most 100 micrometers.

The emulsion oil may be vegetal or mineral. Interestingly, the emulsion oil may be selected as regenerable, so that captured PFAS may be retrieved therefrom after the liquid-liquid separation and PFAS-discharged oil recycled for reuse for example. The emulsion oil may be hydrogenated oil in case of use of the treated water as drinking water for example.

The method comprises selecting the type and the composition of the oil absorption medium used for liquid-liquid separation, according to the target PFAS removal from the PFAS-contaminated water, with an oil absorption capacity in a range between 1000% and 2000% of its weight in oil for example. Micro fibers, open cell media and porous micro beads may be used, for example. For example, PFAS-charged oil is captured by circulating the emulsion through a permeable open cell medium such as a foam sponge, comprising an oleophilic and hydrophobic material, polypropylene or polyurethane for example, or synthetic or natural oloephilic polymers. Regenerable oil absorption medium may be reused after extraction, mechanically by compression for example, of the PFAS-charged oil therefrom. Further retrieving PFAS from the oil extracted from the oil absorption medium may allow recycling the oil.

PFAS is efficiently and cost-effectively removed from the contaminated water, thereby extending the effective life time of granular activated carbon (GAC) or ion exchange resins (IER) filters of downstream filtration steps that may be added for further treatment for example.

In an embodiment of an aspect of the present disclosure, magnetic particles are incorporated in the emulsion oil by mechanical mixing and an an emulsion of microdroplets of the magnetized oil in the contaminated water to be treated is formed; PFAS-charged magnetized oil is then magnetically separated from the water by circulating the emulsion in a magnetizable medium. The magnetic particles may be magnetite and the magnetizable medium may be a zinc-coated aluminum reticulated sponge magnetized by an electric current for example.

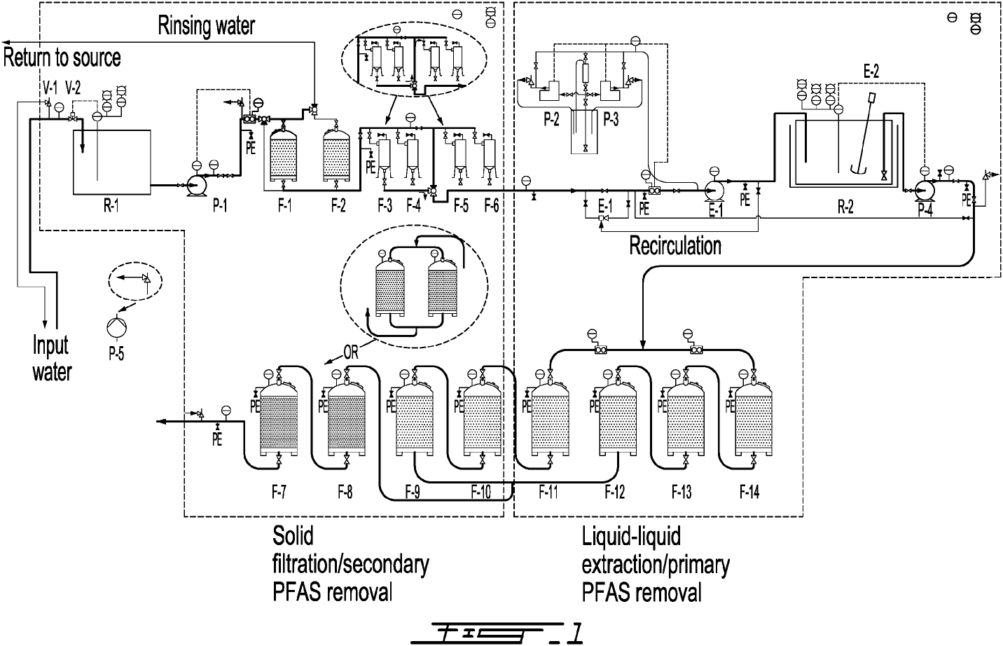

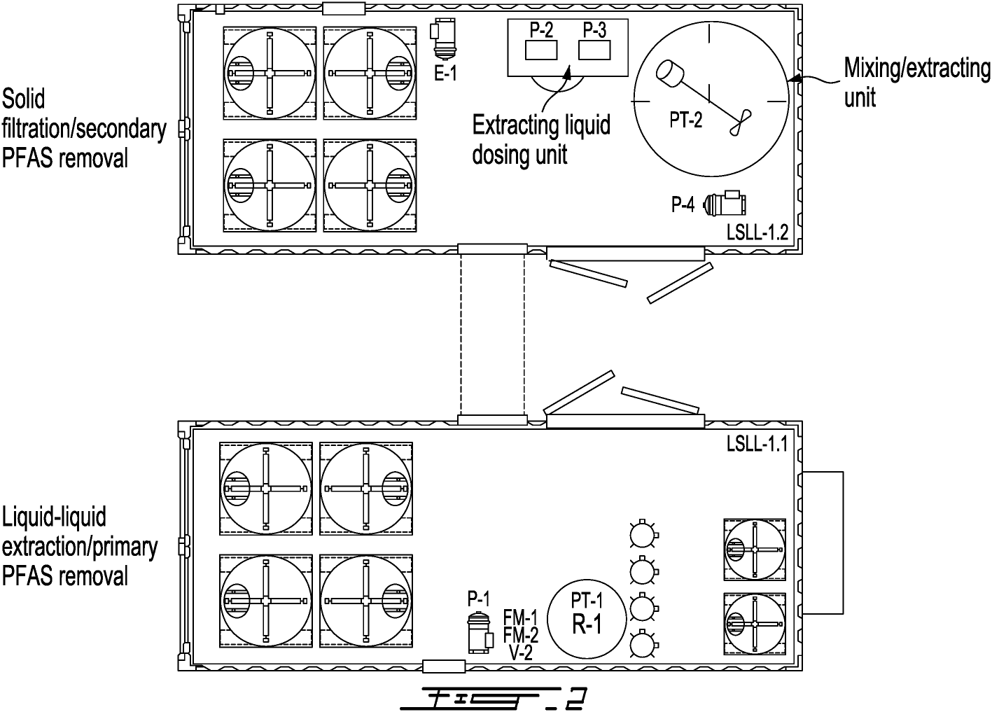

FIGS. 1 and 2 (plan view) show a system according to an embodiment of an aspect of the present disclosure.

First tests of PFAS adsorption at the water/oil interface depending on the contact surface were performed. The tests conditions were as follows: emulsion of a mineral hydrogenated oil ((Voltesso™ 35) at a concentration of 1 mL/L, in military base groundwater (49.1 µg/L of total PFAS); kitchen immersion mixer and mixing times of 2 and 10 minutes; liquid-liquid separation oil absorbing medium: micro polyethylene fibers (Ultrasorption®) impregnated with 20% w/w mineral hydrogenated oil (Voltesso™ 35), empty bed contact time (EBCT), which is defined as the volume of the empty bed divided by the flow rate, and measures the time water is in contact with the oil absorbing medium in liquid -liquid separation, assuming all the water passes through at the same velocity, of 20 minutes. The protocol was as follows: 1. Prepare a 1.5 L emulsion in a 2-L glass beaker. 2. After the mixing time, stop the mixer and filter the emulsion on an micro polyethylene fibers (Ultrasorption®) column. 3. Collect the effluent in a clean glass beaker and measure the turbidity. 4. Filter the effluent collected a second time on the same column of micro polyethylene fibers (Ultrasorption®). 5. Repeat steps 3 and 4 until the turbidity of the effluent is constant. 6. Sample the effluent for PFAS and petroleum hydrocarbons (HP C10-C50). First results showed higher PFAS removal in case of a mixing time of 10 minutes compared to PFAS removal in case of a mixing time of 2 minutes. Although the higher concentration of emulsion oil resulted in a rapid saturation of the micro polyethylene fibers medium, results using an emulsion oil concentration of 250 mL/L and a mixing time of 30 minutes were improved compared to results obtained with a mixing time of 10 minutes and an emulsion oil concentration of 1 mL/L,

Second tests were directed at assessing the impact of emulsion oil concentration on the required mixing time. The tests conditions were as follows: emulsion of mineral hydrogenated oil (Voltesso™ 35) at concentration of 0.01 mL/L in military base groundwater (49.1 µg/L of total PFAS); kitchen immersion mixer and mixing times of 30, 60, 90 and 120 minutes; liquid-liquid separation absorbing medium: micro polyethylene fibers (Ultrasorption®) impregnated with 20% w/w mineral hydrogenated oil (Voltesso™35), empty bed contact time (EBCT) 15 minutes. The protocol was as follows: 1. Wash the columns and a bucket (20 L, HDPE) with Alconox® and rinse 6 times with tap water; 2. fill the bucket with 16 L of military base groundwater; measured with graduated polypropylene cylinder, 2 L; Measure the water temperature; 3. Prepare a concentrated emulsion 1 mL/L in 1 L of tap water - beaker 2 L, mixing for 30 seconds then transfer 160 mL of the emulsion to the military base groundwater bucket using a graduated glass cylinder; 4. Mix the emulsion with the kitchen immersion blender for 10 minutes continuously directly in the bucket and measure the emulsion turbidity and sample for HP C10-C50 analysis; 5. Start column filtration; every 5 minutes, mix the emulsion with the kitchen immersion blender for 1 minute, directly in the bucket; 6. After 15 minutes of filtration (1 column volume replacement), sample the column effluent to analyze PFAS concentrations, HP C10-C50 and turbidity in the treated water; 7. After 45, 75, 105 and 135 minutes of filtration, repeat the sampling step.

At a concentration of 0.01 mL/L and 30 minutes of mixing, the PFAS removal was similar to the removal obtained with the emulsion at 1 mL/L and 10 minutes of mixing. For a given emulsion oil concentration, removal was reduced from 62% to 32% with increased mixing time, suggesting a reduction of the available oil/water interface for PFAS adsorption and PFAS remaining dissolved in water. Continuously operating mixers such as batch shear mixers or in-line shear mixers as used in the food and pharmaceutical industries may be used for practical operations.

Different emulsion oils were tested. A non-food grade mineral hydrogenated oil (Voltesso™ 35) was selected as the oil for the preparation of reference emulsions and food grade oils, such as odorless and colorless oils were then used: light mineral oil (Drakeol® 7 NF) and vegetable oil (corn oil). First, the effect on the removal of PFAS was assessed, as follows: emulsion of mineral hydrogenated oil (Voltesso™3)5, light mineral oil (Drakeol® 7 NF), or corn oil, at a concentration of 0.01 mL/L with a military base groundwater (49.1 µg/L of total PFAS); kitchen immersion mixer and mixing times of 10 and 30 minutes; absorbing medium for liquid-liquid separation: 20% micro polyethylene fibers media (Ultrasorption®) impregnated with the same oil used to prepare the emulsion, empty bed contact time (EBCT)15 minutes. The test protocol was as follows :8. Wash the columns and a bucket (20 L, HDPE) with Alconox® and rinse 6 times with tap water; 9. Fill the bucket with 16 L of military base groundwater, measured with graduated polypropylene cylinder, 2 . Measure the water temperature; 10. Prepare a concentrated emulsion (1 mL/L in 1 L of tap water - 2L beaker, mixing for 30 seconds) then transfer 160 mL of the emulsion to the military base groundwater bucket using a graduated glass cylinder; 11. Mix the emulsion with the kitchen immersion blender for 10 minutes continuously, directly in the bucket. Measure the emulsion turbidity and sample for total petroleum hydrocarbons (TPH) analysis; 12. Replace the immersion mixer with the Caframo mixer (600 RPM). Start filtration; 13. After 15 minutes of filtration (1 column volume replacement), sample the column effluent to analyze PFAS, HP C10-C50 and turbidity; 14. After 45 minutes of filtration, repeat the sampling step; 15. Repeat the test with each emulsion oil.

The slow mixing speed (600 RPM) induced coalescence of the oil droplets and thus limited the number of oil droplets, hence the oil/water interface available for PFAS capture from the contaminated water in the emulsion. The tests were repeated using increased mixing speed, as follows: emulsion of mineral hydrogenated oil (Voltesso™ 35), light mineral oil (Drakeol® 7 NF), or corn oil, at a concentration of 0.1 mL/L in military base groundwater (49.1 µg/L of total PFAS); Silverson AX5 mixer - EMSC-F - 6000 RPM and mixing time of 10 minutes; absorbing media for liquid-liquid separation, in parallel: micro polyethylene fibers without oil impregnation (Ultrasorption® 0%), and polyurethane foam 60 ppi 0% i.e. without oil impregnation; empty bed contact time (EBCT) 15 minutes. The protocol used was as follows: 1. Wash the columns and a bucket (20L, HDPE) with Alconox® and rinse 6 times with tap water; 2. Fill the bucket with 18 L of raw military base groundwater (volume measured with graduated polypropylene cylinder, 2 L). Measure the water temperature; 3. Fill the columns with new media (not used in previous tests); 4. Add 1.8 mL of oil (0.1 mL/L concentration) to the bucket (on the water surface) using an automatic pipette (5 mL tip) and prepare the emulsion as indicated in the test conditions; 5. When the emulsion is prepared, measure the turbidity, the total petroleum hydrocarbons (TPH), the temperature, and take photographs of the emulsion under a microscope;. 6. Filter the emulsion for 20 minutes on the columns of absorbing media in parallel. Adjust the flow with clamp type valves at the outlet of each column and check the flow with a graduated cylinder and a timer. The mixer remains operational for the entire test; 7. Sample for PFAS (2× 250 mL bottles), HP C10-C50 and turbidity at the outlet of each column. Measure the temperature of the emulsion.

For quantification of corn oil in water, vegetable O&G, defined as the difference between total and mineral oils and fats (O&G) and mineral O&G, is used for analysis instead of HP C10-C50. With comparable capture of PFAS using mineral hydrogenated oil (Voltesso™ 35) as the emulsion oil and micro polyethylene fibers (Ultrasorption®) for liquid-liquid separation, using the mineral oil (Drakeol® 7 NF) oil appears as a food grade alternative emulsion oil, while the vegetable oil (corn oil), composed of fatty acids, appears poorly efficient in PFAS removal. The polyurethane foam with 60 pores per inch (ppi) was less effective than the micro polyethylene fibers medium (Ultrasorption®) in HP C10-C50 analysis for PFAS-charge oil / water separation.

Tests were also performed for the selection of absorbing medium for liquid-liquid separation in view of minimizing the contact time for liquid-liquid separation and minimize columns, and thus reduce capital costs; optimizing the absorption capacity for liquid-liquid separation, in view of optimizing replacement and thus reduce operating costs; or media regeneration, so as to reduce costs and volume of absorbing media requiring disposal; and in view of reusing unsaturated oil once separated from water. First tests of absorption in free phase were done to determine the oil absorption capacity of different absorbent media: Micro polyethylene fibers non-pre-impregnated with the emulsion oil (Ultrasorption® DRY or 0%,); polyurethane foam (PU); polypropylene porous beads (Polyform®); polypropylene beads (PP); polyethylene porous beads 30 ppi 60 ppi (Accurel®); recycled polyethylene porous beads (1.3 cf Accurel XP-100®); pores fibers (Accurel XP-500® porous Ethylene-vinyl acetate (EVA) carrier), open structure 800 µm-400 µm, 20 - 80 µm, 20 - 80 µm. The protocol was as follows: 1. For each absorbing medium, obtain a sample of approximately 50 mL and weigh. 2. For each absorbing medium, soak for about 2 minutes in an excess of mineral hydrogenated oil (Voltesso™35). Weigh again. 3. For polyurethane foam wring out by hand and weigh the media, to assess regenerability.

Micro polyethylene fibers (Ultrasorption®) and polyurethane foam (60 ppi) were most effective absorbing media in terms of oil mass absorbed per unit mass of media. Micro polyethylene fibers media (Ultrasorption®) although most effective in terms of mass of oil absorbed per unit volume of media, are not regenerable, whereas it was possible to recover about 75% of the absorbed oil by wringing the polyurethane foam (60 ppi) after liquid-liquid separation. In case of porous beads, once the oil adhered to the beads surface, slow diffusion of oil in the beads may impact efficiency of absorption; and in case of rapid diffusion, recovery of the oil from the beads pores may be difficult depending on the size of the pores, which may cause the permanent fouling of the beads, hence inefficiency thereof.

Tests of absorption media for liquid-liquid separation were carried out to compare the effectiveness of different absorption media in terms of the contact time required to completely filter an emulsion, as follows: emulsion of mineral hydrogenated oil (Voltesso™ 35) at a concentration 0.01 mL/L in city drinking water; kitchen immersion mixer and mixing time of 10 minutes; absorbent for liquid-liquid separation: micro polyethylene fibers (Ultrasorption®) without oil impregnation, micro polyethylene fibers (Ultrasorption®) impregnated with 20% mineral hydrogenated oil (Voltesso™35) or polyurethane foam 30 ppi without oil impregnation, empty bed contact time (EBCT) 15, 30, 45, and 60 minutes. The protocol was as follows: 1. For each media, prepare 4 columns in series of empty bed contact time (EBCT) of 15 minutes per column. 2. Prepare an emulsion of mineral hydrogenated oil (Voltesso™35) in 4 L of tap water. 3. Measure the turbidity of the emulsion and of the effluent from each column. Sample 250 mL of emulsion and of the effluent from each column for HP C10-C50 analysis.

The resulting oil separation from the emulsion was the same with micro polyethylene fibers (Ultrasorption®) non-pre-impregnated and pre-impregnated with 20% mineral hydrogenated oil (Voltesso™35), more effective with the micro polyethylene fibers (Ultrasorption®) after 15 minutes contact time than with the polyurethane foam 30 ppi even after 30, 45 and 60 minutes contact times. No removal improvement was obtained after 45 minutes contact time. Polyurethane foam of smaller pores may be a regenerable alternative to micro polyethylene fibers (Ultrasorption®).

Further tests were conducted using oil-impregnated liquid-liquid separation medium. The test conditions used were as follows: military base groundwater (49.1 µg/L of total PFAS); liquid-liquid separation media tested in parallel: micro polyethylene fibers without oil impregnation (Ultrasorption® 0%), micro polyethylene fibers (Ultrasorption®) impregnated with 20% light mineral oil (Drakeol® 7 NF), polyurethane foam 60 ppi 0% (without oil impregnation), or polyurethane foam 60 ppi impregnated with 20% light mineral oil (Drakeol® 7 NF), empty bed contact time (EBCT) 15 minutes. The protocol was as follows: 1. Wash the columns and a bucket (20 L, HDPE) with Alconox and rinse 6 times with tap water. 2. Fill the bucket with about 20 L of military base groundwater (precise volume not required since no dosing of oil or preparation of emulsion). 3. Fill the columns with new media (not used in previous tests). 4. Filter the water for 20 minutes, adjust the flow rate with clamp-type valves at the outlet of each column and verify the flow rate with a graduated cylinder and a timer. 5. Sample for PFAS (2x 250 mL bottles) at the outlet of each column.

Results showed that none of the absorbent media released PFAS into the water, thus absence of cross contamination, and all the absorbent media tested efficiently separated PFAS-charged oil from water. Impregnating micro polyethylene fibers with mineral oil improved their performance. The polyurethane foam performances was higher than the micro polyethylene fibers; pre-impregnating the polyurethane foam did not improved performances.

Tests were further carried out to determine parameters for the emulsion. Test conditions were as follows: emulsion of light mineral oil (Drakeol® 7 NF) 7 at a concentration of 0.01 mL/L and 0.1 mL/L in military base groundwater (49.1 µg/L of total PFAS), Silverson AX5 mixer - EMSC-F - 6000 RPM, mixing time of 10 minutes; liquid-liquid separation absorbent media tested in parallel: micro polyethylene fibers not pre-impregnated (Ultrasorption® 0%), micro polyethylene fibers (Ultrasorption®) impregnated with 20% light mineral oil (Drakeol® 7 NF), polyurethane foam 60 ppi 0% (without oil impregnation), polyurethane foam 60 ppi impregnated with 20% light mineral oil (Drakeol® 7 NF), empty bed contact time (EBCT) 15 minutes. Protocol: 1. Wash the columns and a bucket (20 L, HDPE) with Alconox and rinse 6 times with tap water. 2. Fill the bucket with 18 L of military base groundwater (volume measured with graduated polypropylene cylinder, 2 L). Measure the water temperature. 3. Fill the columns with new media (not used in previous tests). 4. Add 1.8 mL of oil (0.1 mL/L concentration) to the bucket on the water surface using an automatic pipette (5 mL tip) and prepare the emulsion as indicated in the test conditions. 5. When the emulsion is prepared, measure the turbidity, the HP C10-C50, the temperature and take pictures of the emulsion under a microscope. 6. Filter the emulsion for 20 minutes on the columns of absorbent media in parallel. Adjust the flow with clamp type valves at the outlet of each column and check the flow with a graduated cylinder and a timer. The mixer remains operational for the entire test. 7. Sample for PFAS (2 × 250 mL bottles), HP C10-C50 and turbidity at the outlet of each column. Measure the temperature of the emulsion. 8. Repeat the test (without cleaning the columns and without replacing the absorbent media) with an emulsion of 0.01 mL/L (therefore, 0.2 mL with an automatic pipette and tip of 1 mL - 0.2 mL is the lower limit of the pipette).

Increasing the oil concentration from 0.01 to 0.1 mL/L resulted in PFAS total removal improved by about 10%, mainly through improved removal of longer PFAS chains. Polyurethane foam media, without impregnation and impregnated with 20% mineral oil, removed less oil than micro polyethylene fibers, without impregnation or impregnated with 20% mineral oil. Polyurethane foam impregnated with 20% mineral oil showed almost no capture at 0.01 mL/L concentration; this test was performed without changing the foam after the 0.1 mL/L concentration test without changing the media, which may thus have been almost saturated., or the mixing time for the emulsion may not be sufficient for absorption of a large amount of PFAS by the emulsion oil. Further tests were conducted with emulsions with increased concentrations (0.5 mL/L and 1 mL/L), mixing times of 10 minutes and 30 minutes, and two adsorption media in parallel, namely non-impregnated micro polyethylene fibers (Ultrasorption®) and non-impregnated polyurethane foam 60ppi. Results showed that the gain in removal efficiency of PFAS is at the expense of increased adsorption media consumption.

There is thus provided a PFAS-contaminated water treatment method, comprising selecting, in combination, extraction liquids, concentration of the extraction liquids, mixing conditions and mixing times; and separating the extraction liquids and water from the emulsion. The method comprises selecting an absorbing medium for the extraction liquids. A regenerable absorbing medium, from which the contaminated oil may be extracted, may be selected, allowing reuse in a closed loop; the contaminated extraction liquids may also be reused until saturation thereof. Reuse and recirculation of, the extraction liquids, whereby the extraction liquids are used until they are saturated with PFAS, is of particular interest in the case of water contaminated with high PFAS concentrations, in the order of a few hundred µg/L, in the range between about 110 and 900 µg/L for example, such as contaminated water originating from military sites or industrial landfills for example.

The method allows minimizing the quantity of residues to dispose of compared to using granular activated carbon (GAC) or ion exchange resins (IER).

A method for soil rehabilitation of PFAS contaminated soils according to an embodiment of an aspect of the present disclosure comprises collecting and isolating contaminated soils in piles, washing the piles of contaminated soils on site with water, collecting the washing waters, forming an emulsion of the washing waters and emulsion oil, and circulating the emulsion in a liquid-liquid separation medium. Underground water barriers may be selectively positioned to collect and treat waters that may flow from the site. Most severe treatment targets for soil and water were achieved by washing the soil with water only. The washing waters are treated at considerably reduced costs compared to treatment based on filtration through granular activated carbon (GAC) and ion exchange resins (IER).

Tests were carried out on contaminated waters from airports and military bases, with PFAS concentrations of the order of 80.000 ng/L. FIG. 1 shows the analyses of the waters before and after the tests. The plot shows the concentration (ng/L) of PFAS (PFOS, PFOA, PFOS + PFOA and PFOS + PFOA + PFHpA + PFNA + PFHxS) in raw water, before liquid-liquid separation; after liquid-liquid separation with oil capture on micro polyethylene fibers (Ultrasorption®). The horizontal lines show criteria for PFOA and PFOS as defined in Vermont, currently one of the most stringent standards in the USA, US EPA, and Canada. The sum of the PFOS + PFOA + PFHpA + PFNA + PFHxS concentrations is indicated on the plot.

The tests also included simulations after filtration on granular activated carbon (GAC) and after ion exchange resins (IER) filtration for example, used as further additional treatment steps. The results meet standards in force in Canada for PFOA and PFOS. After the granular activated carbon (GAC) filtration, US EPA standards for PFOA, PFOS and the sum PFOS + PFOA + PFHpA + PFNA + PFHxS are met, and after the resin filtration step, Vermont standards are met.

The table in FIG. 2 shows detailed results obtained in laboratory tests. Since PFOS has led to fish consumption alerts for several Michigan rivers because it bioaccumulates so readily in fish and has potential human health effects if eaten, Michigan has water quality standards (WQS or Michigan Rule 57 values) for perfluorooctane sulfonate (PFOS) and perfluorooctanoic acid (PFOA); the applicable water quality standard (WQS) for PFOS is set at 12 ppt (parts per trillion, equal to nanograms per liter) for streams that are not used for drinking water and at 11 ppt for streams used as drinking water sources. The applicable water quality standard (WQS) for PFOA is much higher at 12,000 ppt for surface waters that are not used for drinking water and at 420 ppt for surface waters used as drinking water sources.

The results show that a very large proportion of PFAS is removed upstream of the granular activated carbon (GAC) and ion exchange resin (IER) filters, thus reducing the need for granular activated carbon (GAC) or ion exchange resin (IER) filters media replacement or regeneration. The lifespan of granular activated carbon (GAC) polishing filters may be extended by a factor of 3 to 4 (lifespan 3 to 4 times greater with liquid - liquid extraction with micro polyethylene fibers (Ultrasorption®) as described herein for example compared to treatment with granular activated carbon (GAC) filters only). The reduction of cost of treatment of waters may reach 50 to 70 %. For example, considering a treatment at 200 L/min of water contaminated with concentrations of 100,000 ppt in PFAS leading to a change of granular activated carbon (GAC) filters every 3 weeks, the estimated savings in granular activated carbon (GAC) filters media are around $ 400,000 per year per processing unit. If PFAS concentrations double, more than $ 2 million per year per treatment unit may be saved compared to current GAC costs, ion exchange resins (IER)-based media being typically 2 times more expensive to use than granular activated carbon (GAC) media.

The present method comprises identifying and selecting the PFAS-capturing oil to form and control a PFAS absorption surface area selectivity, and the PFAS-capturing oil concentration in th emulsion with the contaminated water to be treated. Furthermore, the charged oil capture media may be selected to allow for its regeneration and recycling, thus minimizing the volume of PFAS-capturing oil and/or charged oil capture media to be disposed of.

There is thus presented herein a method for liquid-liquid extraction for treating large quantities of water contaminated with a range of hydrophobic and lipophilic molecules. The method described herein in relation to PFAS may be used for removal of other persistent, bio -accumulative and toxic contaminants, such as brominated flame retardants such as polybrominated diphenyl ethers (PBDEs) for example, pharmaceuticals and antibiotics products, drug residues, steroids, bisphenol-A, polychlorinated biphenyls (PCBs), dioxins, and furans. The removal method comprises contaminant capture in oil emulsion and liquid/liquid extraction of the contaminant-charged oil from the water, effectively up to high contaminant concentrations and in situations of mixed contamination. In cases when granular activated carbon (GAC) and/or ion exchange resins (IER) filtration are further used for removal completion, since the removal of contaminants is achieved by up to 80 % in the water to be treated after liquid/liquid extraction, the lifespan of granular activated carbon (GAC) and ion exchange resins (IER) media is extended compared to their lifespan when used as primary treatment, and operating costs may be reduced by about 50 to about 70%, in particular in cases of highly contaminated waters to be treated.

In addition to regeneration of contaminated sites as mentioned hereinabove, the present method and system may be applied to treat leachate waters from landfills sites, or from industrial sites, each having specific PFAS contamination issues.

In soil remediation projects where the soil characteristics and PFAS concentrations permit the use of soil washing, the present washing waters treatment method may be used to treat PFAS contaminated water.

The scope of the claims should not be limited by the embodiments set forth in the examples but should be given the broadest interpretation consistent with the description as a whole.

1. A method for treating water contaminated with hydrophobic and lipophilic molecules, comprising forming an emulsion of the contaminated water with an oil; and separating from the emulsion an oil part charged with a captured amount of the hydrophobic and lipophilic molecules and a treated water part, the treated water having an amount the in hydrophobic and lipophilic molecules reduced by the captured amount of hydrophobic and lipophilic molecules than an initial amount of the hydrophobic and lipophilic molecules in the contaminated water.

2. The method of claim 1, comprising selecting the oil in relation to physico-chemical parameters of the contaminated water and to a target captured amount of hydrophobic and lipophilic molecules.

3. The method of claim 1, comprising selecting the oil in relation to physico-chemical parameters of the contaminated water and to a target captured amount of hydrophobic and lipophilic molecules, the method further comprising recycling the oil after said separating the oil part and the water part from the emulsion.

4. The method of claim 1, comprising selecting the oil in relation to at least one of: concentration and signature of the hydrophobic and lipophilic molecules, competing elements, competing contaminants, competing metals, pH and temperature of the contaminated water, and to a target captured amount of hydrophobic and lipophilic molecules.

5. The method of claim 1, comprising selecting at least one of: type of the oil, composition of the oil, and concentration of the oil in the emulsion in relation to physico-chemical parameters of the contaminated water and to a target captured amount of hydrophobic and lipophilic molecules.

6. The method of claim 1, wherein said forming the emulsion of the contaminated water with the oil comprises forming an emulsion of the oil in clean water and injection the emulsion into the contaminated water.

7. The method of claim 1, comprising incorporating magnetic particles in the oil prior to forming the emulsion, and magnetically separating hydrophobic and lipophilic molecules-charged magnetized oil and water from the emulsion by circulating the emulsion in a magnetizable medium.

8. The method of claim 1, comprising selecting a combination of : selecting at least one of : molecular composition of the oil, viscosity of the oil, density of the oil and interfacial tension of the oil, in combination with mixing shearing speed and mixing time, in relation to physico-chemical parameters of the contaminated water and to a target captured amount of hydrophobic and lipophilic molecules.

9. The method of claim 1, comprising selecting at least one of : molecular composition of the oil, viscosity of the oil, density of the oil and interfacial tension of the oil, in combination with mixing shearing speed and mixing time, to achieve a target size of oil droplets of at most 100 micrometers in the emulsion.

10. The method of claim 1, comprising selecting an oleophilic and hydrophobic medium and circulating the emulsion through the oleophilic and hydrophobic medium.

11. The method of claim 1, comprising selecting an oleophilic and hydrophobic medium and circulating the emulsion through the oleophilic and hydrophobic medium, thereby separating the oil part being charged with the captured amount of oleophilic and hydrophobic molecules and the treated water; and retrieving the captured amount of oleophilic and hydrophobic medium from the oil part.

12. The method of claim 1, comprising selecting an oleophilic and hydrophobic medium and circulating the emulsion through the oleophilic and hydrophobic medium, thereby separating the captured amount of oleophilic and hydrophobic medium in the oil part and the treated water part; retrieving the oil part from the oleophilic and hydrophobic medium, and at least one of: recycling the oil part and recycling the oleophilic and hydrophobic medium.

13. The method of claim 1, comprising selecting an oleophilic and hydrophobic medium with an oil absorption capacity in a range between 1000% and 2000% of a weight thereof in oil and circulating the emulsion through the oleophilic and hydrophobic medium.

14. The method of claim 1, comprising selecting one of : mineral oils and vegetable oils, and circulating the emulsion through an oleophilic and hydrophobic medium comprising one of: micro fibers, open cell material and porous beads.

15. The method of claim 1, comprising selecting an oleophilic and hydrophobic absorbing medium and circulating the emulsion through the oleophilic and hydrophobic absorbing medium, thereby separating the captured amount of oleophilic and hydrophobic molecules in the oil part from the water part; retrieving the captured amount of oleophilic and hydrophobic from the absorbing medium, and at least one of: recycling the oil part; recycling the absorbing medium; and circulating the water part though at least one of: granular activated carbon (GAC) or ion exchange resins (IER) filters.
